(19) United States
(12) Patent Application Publication
(10) Pub. No.: US 2006/0088170 A1
(43) Pub. Date: Apr. 27, 2006

(54) Audio appliance

(76) Inventors: Dennis R. Esterberg, Philomath, OR (US); Glen A. Oross, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/995,606

(22) Filed: Nov. 22, 2004

Related U.S. Application Data
(60) Provisional application No. 60/621,157, filed on Oct. 22, 2004.

(51) Int. Cl. H04R 29/00

(52) U.S. Cl. 381/58; 381/1; 381/56

(57) ABSTRACT

An embodiment of an audio appliance includes a housing containing first, second, third, and fourth audio monitors. The first and second audio monitors are configured to broadcast a stereo output in a first direction relative to the housing. The third and fourth audio monitors are configured to broadcast the stereo output in a second direction generally opposite the first direction.

### BACKGROUND

Portable audio appliances commonly known as “boom boxes” allow consumers enjoy news, music, and other entertainment. Typically, such appliances include a housing with audio monitors (speakers) positioned to broadcast stereo output in a single direction toward an audience. This poses a problem when audience members are situated around the appliance. When the appliance is situated to broadcast the stereo output to some audience menders, other audience members will enjoy less than full performance of audio quality. In other words, the stereo output will be broadcast toward some audience members and away from others.

### DESCRIPTION OF THE DRAWINGS

FIGS. 1 and 2 are perspective views of an audio appliance according to an embodiment of the present invention.

FIG. 3 is a side view of the audio appliance showing a DVD tray according to an embodiment of the present invention.

FIG. 4 is a rear view of the audio appliance according to an embodiment of the present invention.

FIG. 5 is a top view showing the positioning of the audio monitors within the audio appliance according to an embodiment of the present invention.

FIG. 5 is a schematic view of the audio appliance showing the inclusion of an audio and video source, a projector, and an amplifier according to an embodiment of the present invention.

### DETAILED DESCRIPTION

Various embodiments provide an audio appliance for broadcasting a stereo output. The appliance includes a number of audio monitors positioned so that audience members situated around the appliance are each able to enjoy the same quality stereo output regardless of being positioned in front, behind, or beside the appliance.

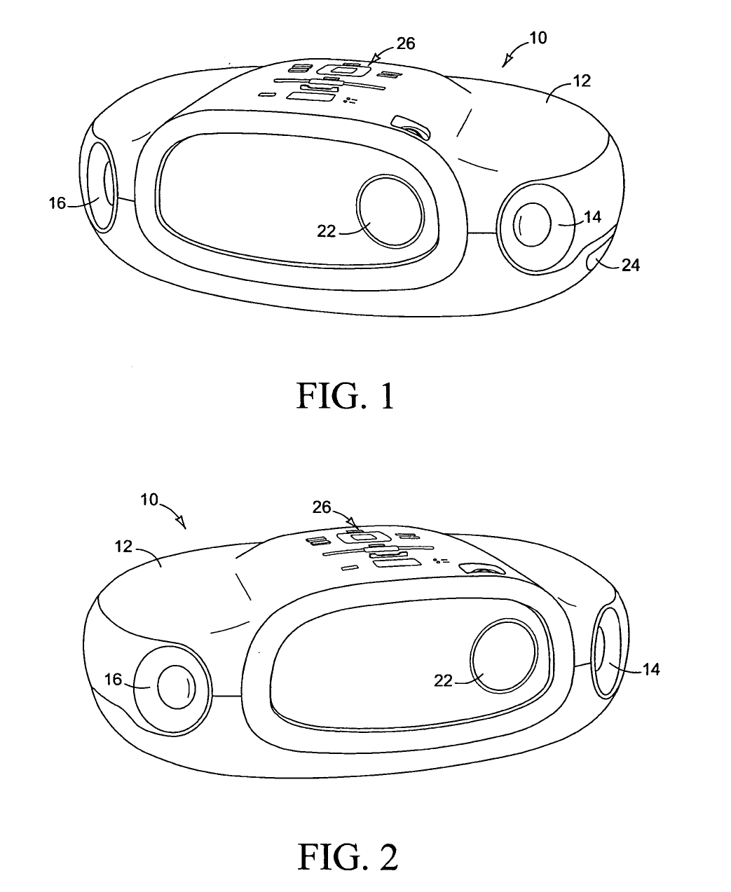

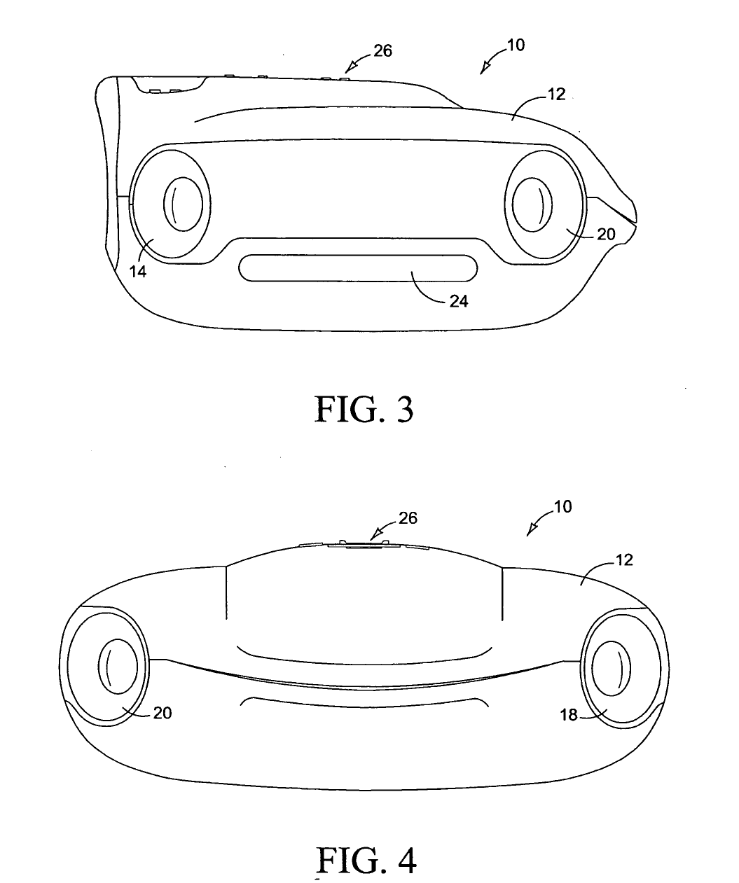

FIGS. 1-14 illustrate an exemplary audio appliance 10. As shown audio appliance 10 is a “video boom-box” capable of projecting images on a screen or other target while broadcasting a stereo output. Audio appliance 10 includes housing 12, audio monitors 14-20, projector 22, multimedia player 24, and user interface 26. Audio monitors 14-20 are positioned outwardly around a perimeter of housing 12. Projector 22 is positioned to cast images outward from housing 12 from a point between audio monitors 14 and 16.

Multimedia player 24 is shown as a DVD (Digital Video Disc) player supplying an audio signal and a corresponding video signal. The audio signal defines a stereo output broadcast by audio monitors 14-20 while the video signal defines the images cast by projector 22. User interface 26 includes controls for directing the operation of multimedia player 24 and projector 22 and for controlling the volume level for audio monitors 14-20.

While audio appliance 10 is shown to include multimedia player 24 in the form of a DVD player, multimedia player 24 is not limited to a DVD player. Multimedia player 24 represents generally any combination of hardware and/or programming capable of providing a video signal to projector 22 and an audio signal to be broadcast be audio monitors 14-20. For example, multimedia player 24 may include a memory storing multimedia content, program instructions for playing the content, and a processor for executing the program instructions. Alternatively, audio appliance 10 may simply include an audio input interface and a video input interface accepting audio and video signals from an external source or sources.

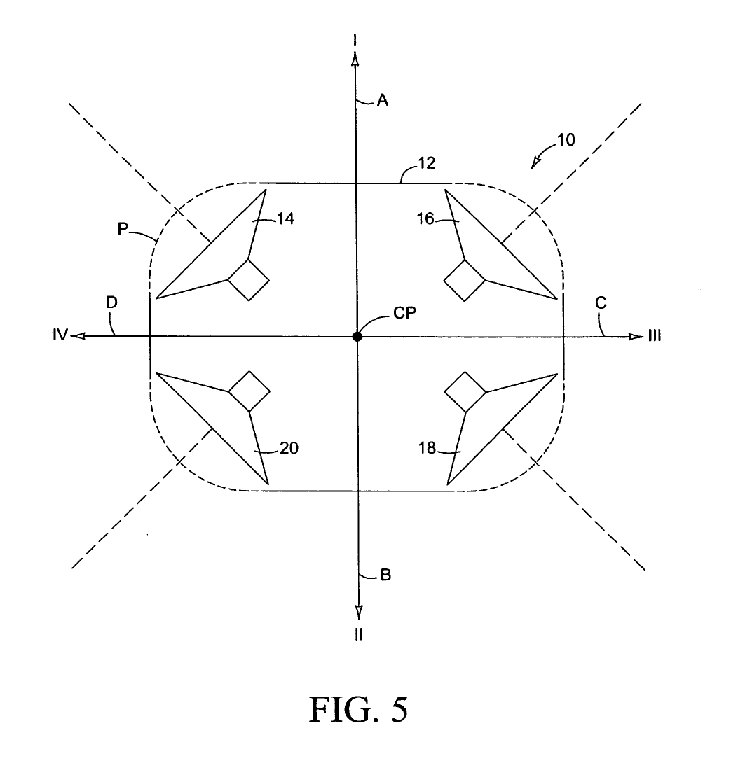

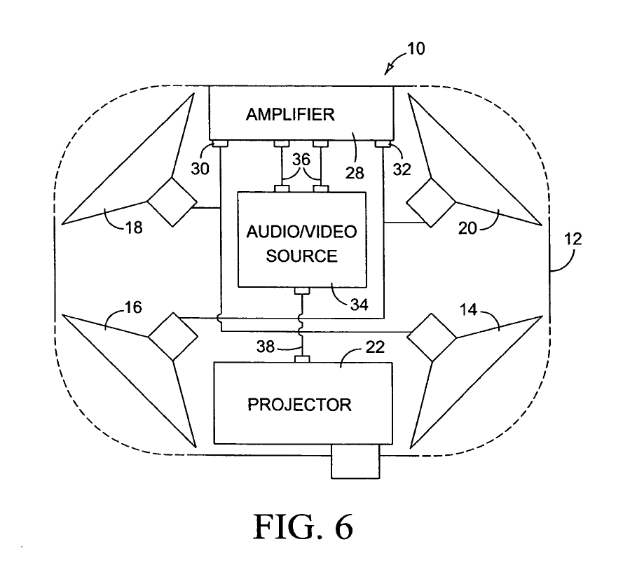

FIG. 5 is a top schematic view of audio device 10 that helps illustrate an exemplary placement of audio monitors 14-20. As shown, hosing 12 has an outer perimeter (P) and a center point (CP). The space surrounding housing 12 is divided into quadrants (I), (II), (III), and (IV). Audio monitors 14-20 are positioned around perimeter (P) and directed to broadcast outward from center point (CP). Audio monitors 14 and 16 are positioned to broadcast a stereo output outward from center point (CP) in direction (A) toward quadrant (I). Audio monitors 18 and 20 are positioned to broadcast the stereo output outward from center point (CP) in direction (B) toward quadrant (II). Audio monitors 16 and 18 are positioned to broadcast the stereo output outward from center point (CP) in direction (C) toward quadrant (III). Audio monitors 14 and 20 are positioned to broadcast the stereo output outward from center point (CP) in direction (D) toward quadrant (IV).

As can be seen in FIG. 5, direction (A) is generally opposite of direction (B), and direction (C) is generally opposite of direction (D). Directions (A) and (B) are generally orthogonal to directions (C) and (D). Similarly, quadrant (I) is generally opposite quadrant (II). Quadrant (III) is adjacent to quadrants (I) and (II), while quadrant (IV) is adjacent to quadrants (I) and (II) but generally opposite quadrant (III). Positioning audio monitors in this orientation allows an audience member to enjoy consistent audio quality regardless of which quadrant (I), (II), (III), or (IV) the audience member is situated relative to audio appliance 10.

FIG. 6 is an exemplary top schematic view of audio appliance 10 showing the inclusion of projector 22 and amplifier 28. Projector 22 is positioned to cast images in direction (A) from between audio monitors 14 and 16. Amplifier 28 represents generally any audio amplifier capable accepting an audio input and supplying a corresponding stereo output to audio monitors 14-20. Amplifier 28 includes first and second audio channels 30 and 32. Audio channel 30 is coupled to audio monitors 14 and 18. Audio channel 32 is coupled to audio monitors 16 and 20. In this manner, the same stereo output from amplifier 28 can be broadcast by audio monitors 14-20 to quadrants (I), (II), (III), and (IV).

Audience members in quadrants (I) and (IV) enjoy the broadcast of channel 30 from audio monitor 14, while members in quadrant (IV) enjoy the broadcast of channel 32 from audio monitor 20, and members in quadrant (I) enjoy the broadcast of channel 32 from audio monitor 16. Audience members in quadrants (II) and (III) enjoy the broadcast of channel 30 from audio monitor 18, while members in quadrant (II) enjoy the broadcast of channel 32 from audio monitor 20, and members in quadrant (III) enjoy the broadcast of channel 32 from audio monitor 16.

Audio/video source 34 represents generally any source capable of supplying a video signal to projector 22 and an audio signal to amplifier 28. For example, audio/video source 34 may be a multimedia player 24 (FIGS. 1-3) or simply an interface for receiving audio and video signals from an external source. As shown, audio/video source 34 is coupled to amplifier 36 at audio input 36. Audio/video source 34 is coupled to projector 22 at video input 38. in an alternative embodiment, audio/video source 34 may incorporate multimedia player 24 and amplifier 28.

FIGS. 1-6 illustrate various embodiments of the present invention. The figures illustrate various implementations of an audio appliance and its use. While the present invention has been shown and described with reference to the foregoing exemplary embodiments, it is to be understood that other forms, details, and embodiments may be made without departing from the spirit and scope of the invention which is defined in the following claims.

What is claimed is:

1. An audio appliance, comprising a housing containing first, second, third, and fourth audio monitors, wherein:
the first and second audio monitors are configured to broadcast a stereo output in a first direction relative to the housing; and
the third and fourth audio monitors are configured to broadcast the stereo output in a second direction generally opposite the first direction.

2. The audio appliance of claim 1, further comprising an amplifier providing a stereo signal to the first and second audio monitors and to the third and fourth audio monitors, the stereo signal defining the stereo output.

3. The audio appliance of claim 1, further comprising:
a projector contained within the housing and configured to cast images on a target;
a video source for providing a video input signal to the projector, the video input signal defining the images cast by the projector; and
an audio source for providing a stereo signal to the first and second audio monitors and to the third and fourth audio monitors, the stereo signal defining the stereo output.

4. The audio appliance of claim 1, wherein:
the second and third audio monitors are configured to broadcast the stereo output in a third direction generally orthogonal to the first and second directions; and
the first and fourth audio monitors are configured to broadcast the stereo output in a fourth direction generally opposite the third direction.

5. The audio appliance of claim 4, further comprising an amplifier providing a first audio channel to the first and third audio monitors and a second audio channel to the second and fourth audio monitors.

6. The audio appliance of claim 4, further comprising:
a projector contained within the housing and configured to cast images on a target; and
a video source for providing a video signal to the projector, the video input signal defining the images cast by the projector; and
an audio source for providing a first audio signal to the first and third audio monitors and a second audio signal to the second and fourth audio monitors, the first and second audio signals defining the stereo output.

7. An electronic appliance: comprising:
a housing containing first, second, third, and fourth audio monitors, a projector configured to cast an image on a target, and a multimedia player configured to supply the projector with a video signal defining the images and to supply the audio monitors with a audio signal defining a stereo output, wherein:
the first and second audio monitors are configured to broadcast the stereo output in a first direction relative to the housing; and
the third and fourth audio monitors are configured to broadcast the stereo output in a second direction generally opposite the first direction.
the second and third audio monitors are configured to broadcast the stereo output in a third direction generally orthogonal to the first and second directions; and
the first and fourth audio monitors are configured to broadcast the stereo output in a fourth direction generally opposite the third direction.

8. The electronic appliance of claim 7, wherein the multimedia player includes an amplifier providing a first audio channel to the first and third audio monitors and a second audio channel to the second and fourth audio monitors.

9. An audio appliance, comprising:
a housing;
first, second, third, and fourth, audio monitors sequentially positioned around a perimeter of the housing; and
an amplifier providing a first audio channel to the first and third audio monitors and a second audio channel to the second and fourth audio monitors.

10. The audio appliance of claim 9, wherein:
the first and second audio channels are configured to supply a signal defining a stereo output;
the first and second audio monitors are positioned to broadcast the stereo output to a first quadrant extending away from the housing; and
the third and fourth audio monitors are positioned to broadcast the stereo output to a second quadrant generally opposite the first quadrant.

11. The audio appliance of claim 10, wherein:
the second and third audio monitors are positioned to broadcast the stereo output to a third quadrant adjacent to the first and second quadrants; and
the first and fourth audio monitors are positioned to broadcast the stereo output to a fourth quadrant generally opposite the third quadrant.

12. The audio appliance of claim 9, further comprising:
a projector configured to cast images on a target;
a video source for providing a video signal to the projector, the video input signal defining the images cast by the projector; and
an audio source for providing the amplifier with audio signals defining a stereo output to be supplied through the first and second channels.

13. The audio appliance of claim 9, further comprising:
a projector configured to cast images on a target; and
a multimedia player configured to provide the amplifier with audio signals defining a stereo output to be supplied through the first and second channels and to provide the projector with a video signal defining the images to be cast.

14. An electronic appliance, comprising:
a housing;
first, second, third, and fourth, audio monitors sequentially positioned around a perimeter of the housing;
an amplifier providing a first audio channel to the first and third audio monitors and a second audio channel to the second and fourth audio monitors;
a projector configured to cast images on a target; and
a multimedia player configured to provide the amplifier with audio signals defining a stereo output to be supplied through the first and second channels and to provide the projector with a video signal defining the images to be cast.

15. The electronic appliance of claim 14, wherein:
the first and second audio channels are configured to supply a signal defining a stereo output;
the first and second audio monitors are positioned to broadcast the stereo output to a first quadrant extending away from the housing;
the third and fourth audio monitors are positioned to broadcast the stereo output to a second quadrant generally opposite the first quadrant;
the second and third audio monitors are positioned to broadcast the stereo output to a third quadrant adjacent to the first and second quadrants; and
the first and fourth audio monitors are positioned to broadcast the stereo output to a fourth quadrant generally opposite the third quadrant.

16. A method for manufacturing an audio device, comprising:
providing a housing;
sequentially positioning first, second, third, and fourth, audio monitors around a perimeter of the housing;
coupling a first audio channel to the first and third audio monitors; and
coupling a second audio channel to the second and fourth audio monitors.

17. The method of claim 16, wherein positioning comprises:
positioning the first and second audio monitors to broadcast a stereo output to a first quadrant extending away from the housing; and
positioning the third and fourth audio monitors to broadcast the stereo output to a second quadrant generally opposite the first quadrant.

18. The method of claim 17, wherein positioning comprises:
positioning the second and third audio monitors to broadcast the stereo output to a third quadrant adjacent to the first and second quadrants; and
the first and fourth audio monitors are positioned to broadcast the stereo output to a fourth quadrant generally opposite the third quadrant.

19. The method of claim 16, further comprising:
positioning an amplifier within the housing, the amplifier supplying the first audio channel and the second audio channel;
positioning a projector within the housing, the projector operable to cast images on a target outside the housing; and
positioning a multimedia player within the housing, the multimedia player having an audio interface coupled to the amplifier and a video interface coupled to the projector.

20. A method for manufacturing an audio device, comprising:
providing a housing;
sequentially positioning first, second, third, and fourth, audio monitors around a perimeter of the housing;
coupling a first audio channel to the first and third audio monitors;
coupling a second audio channel to the second and fourth audio monitors;
positioning an amplifier within the housing, the amplifier supplying the first audio channel and the second audio channel;
positioning a projector within the housing, the projector operable to cast images on a target outside the housing; and
positioning a multimedia player within the housing, the multimedia player having an audio interface coupled to the amplifier and a video interface coupled to the projector.

21. The method of claim 20, wherein positioning the first, second, third, and fourth audio monitors comprises:
positioning the first and second audio monitors to broadcast a stereo output to a first quadrant extending away from the housing;
positioning the third and fourth audio monitors to broadcast the stereo output to a second quadrant generally opposite the first quadrant;
positioning the second and third audio monitors to broadcast the stereo output to a third quadrant adjacent to the first and second quadrants; and
positioning the first and fourth audio monitors to broadcast the stereo output to a fourth quadrant generally opposite the third quadrant

22. A method for broadcasting a stereo output:
broadcasting the stereo output to a first quadrant extending outward from a central point;
broadcasting the stereo output to a second quadrant generally opposite the first quadrant;
broadcasting the stereo output to a third quadrant adjacent to the first and second quadrants; and
broadcasting the stereo output to a fourth quadrant generally opposite the third quadrant.

23. The method of claim 22, further comprising:
playing multimedia content supplying a video signal and an audio signal, the audio signal defining the stereo output;
projecting, outward from the central point, images on a target, the images being defined by the video signal.

24. An audio appliance, comprising:
a housing;
a means for providing a first audio channel and a second audio channel for supplying a stereo output;
a means for broadcasting the stereo output to a first quadrant extending away from the housing;
a means for broadcasting the stereo output to a second quadrant generally opposite the first quadrant;
a means for broadcasting the stereo output to a third quadrant adjacent to the first and second quadrants; and
a means for broadcasting the stereo output to a fourth quadrant generally opposite the third quadrant.

25. The audio appliance of claim 24, further comprising:
a means for projecting, outward from the housing, images on a target;
a means for providing a video signal to the projector, the video signal defining the images;
a means for providing an audio signal to the means for providing the first and second audio channels, the audio signal defining the stereo output.
